(19) United States
(12) Patent Application Publication
(10) Pub. No.: US 2025/0231863 A1
(43) Pub. Date: Jul. 17, 2025

(54) COMPUTE-IN-MEMORY CIRCUITS AND METHODS FOR OPERATING THE SAME

(71) Applicant: Taiwan Semiconductor Manufacturing Company, Ltd., Hsinchu (TW)

(72) Inventors: Sheng-Chih Lai, Hsinchu City (TW); Chieh-Fang Chen, Hsinchu City (TW); Chen-Jun Wu, Hsinchu City (TW)

(73) Assignee: Taiwan Semiconductor Manufacturing Company, Ltd., Hsinchu (TW)

(21) Appl. No.: 18/735,949

(22) Filed: Jun. 6, 2024

Related U.S. Application Data
(60) Provisional application No. 63/621,245, filed on Jan. 16, 2024.

(51) Int. Cl. G06F 12/02; G06F 7/544

(52) U.S. Cl. CPC G06F 12/0223; G06F 7/5443

(57) ABSTRACT

A memory circuit includes a first memory array comprising a plurality of first memory cells, the plurality of first memory cells configured to store a first data element; a second memory array comprising a plurality of second memory cells, the plurality of second memory cells configured to store a second data element; and a control circuit operatively coupled to both of the first memory array and the second memory array, and configured to provide a multiply-accumulate (MAC) value at least based on simultaneously multiplying a third data element by the first data element and multiplying the third data element by the second data element.

### CROSS-REFERENCE TO RELATED APPLICATION

This application claims priority to and the benefit of U.S. Provisional Application No. 63/621,245, filed Jan. 16, 2024, which is incorporated herein by reference in its entirety for all purposes.

### BACKGROUND

The semiconductor industry has experienced rapid growth due to continuous improvements in the integration density of a variety of electronic components (e.g., transistors, diodes, resistors, capacitors, etc.). For the most part, this improvement in integration density has come from repeated reductions in minimum feature size, which allows more components to be integrated into a given area.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates an example neural network, in accordance with some embodiments.

FIG. 2 illustrates a block diagram of a Compute-in-Memory (CiM) system, in accordance with some embodiments.

FIG. 3 illustrates a schematic diagram of the CiM system of FIG. 2, in accordance with some embodiments.

FIG. 4 illustrates an example implementation of a portion of the CiM system of FIG. 2, in accordance with some embodiments.

FIG. 5 illustrates waveforms of signals to operate the implementation of FIG. 4, in accordance with some embodiments.

FIG. 6 illustrates another example implementation of a portion of the CiM system of FIG. 2, in accordance with some embodiments.

FIG. 7 illustrates waveforms of signals to operate the implementation of FIG. 6, in accordance with some embodiments.

FIG. 8 illustrates yet another example implementation of a portion of the CiM system of FIG. 2, in accordance with some embodiments.

FIG. 9 illustrates waveforms of signals to operate the implementation of FIG. 8, in accordance with some embodiments.

FIG. 10 illustrates an example flow chart for operating a CiM system, in accordance with some embodiments.

FIG. 11 a perspective view of a CiM system that are formed across multiple physical layers, in accordance with some embodiments.

FIG. 12 illustrates a flow chart of an example method to form a memory system with different layers, in accordance with some embodiments.

FIGS. 13A, 13B, 13C, 13D, and 13E illustrates various cross-sectional views of a device formed based on the method of FIG. 12, in accordance with some embodiments.

FIG. 14 illustrates a flow chart of another example method to form a memory system with different layers, in accordance with some embodiments.

FIGS. 15A, 15B, 15C, 15D, and 15E illustrates various cross-sectional views of a memory device formed based on the method of FIG. 14, in accordance with some embodiments.

FIG. 16 illustrates a flow chart of yet another example method to form a memory system with different layers, in accordance with some embodiments.

FIG. 17 illustrates a cross-sectional view of an example transistor formed in a metallization layer, in accordance with some embodiments.

FIG. 18 illustrates a cross-sectional view of another example transistor formed in a metallization layer, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

With advances in modern day semiconductor manufacturing processes and the continually increasing amounts of data generated, there is an ever greater need to store and process large amounts of data, and therefore a motivation to find improved ways of storing and processing large amounts of data. Although it is possible to process large quantities of data in software using conventional computer hardware, existing computer hardware can be inefficient for some data-processing applications.

In this regard, machine learning has emerged as an effective way to analyze and derive value from such large quantities of data. Generally, machine learning is a field of computer science that involves algorithms that allow computers to “learn” (e.g., improve performance of a task) without being explicitly programmed. Machine learning can involve different techniques for analyzing data to improve upon a task. One such technique (such as deep learning) is based on neural networks. However, machine learning performed on conventional computer systems can involve excessive data transfers between memory and the processor, leading to high power consumption and slow compute times.

Compute-in-Memory (CiM) (which can also be referred to as in-memory processing) involves performing compute operations within a memory array. Stated another way, compute operations are performed directly on the data read from the memory cells instead of transferring the data to a digital processor for processing. By avoiding transferring some data to the digital processor, the bandwidth limitations associated with transferring data back and forth between the processor and memory in a conventional computer system are reduced.

One application for such a CiM is artificial intelligence (AI), and specifically machine learning. For example, a computing system (e.g., a CiM system) can use multiple layers of computational nodes, where lower layers perform computations based on results of computations performed by higher layers. These computations sometimes may rely on the computation of dot-products and absolute difference of vectors, typically computed with MAC (operations) performed on the parameters, e.g., an input data element and a weight data element. The term “MAC” can refer to multiply-accumulate, multiplication/accumulation, or multiplier accumulator, in general referring to an operation that includes the multiplication of two values, and the accumulation of a sequence of multiplications.

In the existing technologies, the memory array of a CiM system typically extends only in lateral directions. Accordingly, to include an increasing number of memory cells in the memory array (e.g., with the trend of processing an increasing amount of data), access lines of the memory array can only extend in the lateral directions. The increased length of the access line increases an IR drop presented on the access line, which disadvantageously impacts performance (e.g., speed) of the CiM system. Stated another way, a trade-off between the IR drop and a size of the memory array of the existing CiM system commonly exists. Thus, the exiting CiM system has not been entirely satisfactory in certain aspects.

The present disclosure provides various embodiments of a CiM system that can efficiently output a number of MAC values based on simultaneously accessing a plural number of memory arrays respectively formed in different physical layers. In one aspect, the CiM system, as disclosed herein, can include a plural number of memory arrays formed in respectively different physical layers. Such physical layers can be vertically spaced from one another, which allows the memory arrays of the disclosed CiM system to be stacked on top of one another. With the memory arrays formed in different physical layers, multiple data elements (or multiple bits of a first data element) that are respectively programmed into the memory arrays can be simultaneously read out. As such, the CiM system can simultaneously perform multiple MAC operations to generate one or more MAC values. For example, upon reading a first data element (e.g., a first weight data element) and a second data element (e.g., a second weight data element), the CiM system can multiply a third data element (e.g., an input data element) by the first data element and by the second data element at the same time. Consequently, without increasing the IR drop (e.g., through vertically stacking memory arrays in respectively different layers), a number of memory cells of the disclosed CiM system can be significantly increased.

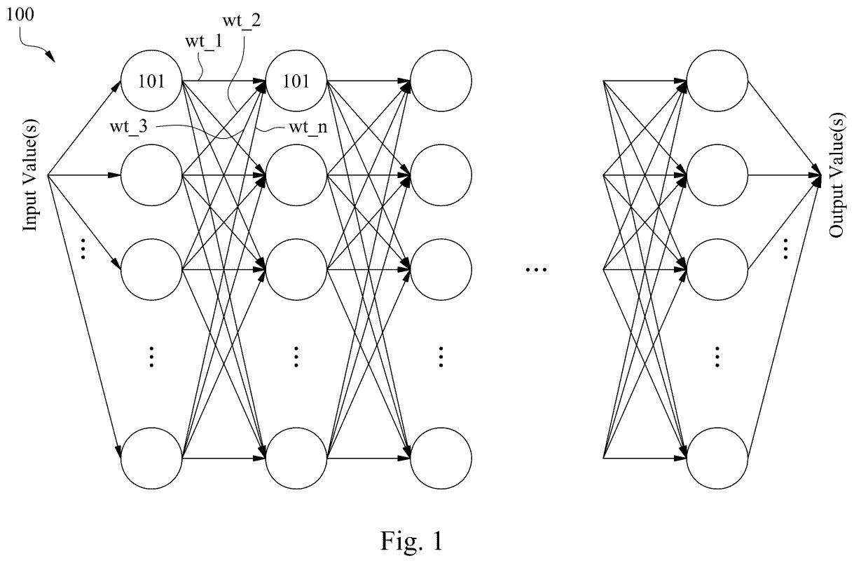

FIG. 1 depicts an example neural network 100, in accordance with various embodiments. As shown, the inner layers of a neural network can largely be viewed as layers of neurons that each receive weighted outputs from the neurons of other (e.g., preceding) layer(s) of neurons in a mesh-like interconnection structure between layers. The weight of the connection from the output of a particular preceding neuron to the input of another subsequent neuron is set according to the influence or effect that the preceding neuron is to have on the subsequent neuron (for simplicity, only one neuron 101 and the weights of input connections are labeled). Here, the output value of the preceding neuron is multiplied by the weight of its connection to the subsequent neuron to determine the particular stimulus that the preceding neuron presents to the subsequent neuron.

A neuron's total input stimulus corresponds to the combined stimulation of all of its weighted input connections. According to various implementations, if a neuron's total input stimulus exceeds some threshold, the neuron is triggered to perform some, e.g., linear or non-linear mathematical function on its input stimulus. The output of the mathematical function corresponds to the output of the neuron which is subsequently multiplied by the respective weights of the neuron's output connections to its following neurons.

Generally, the more connections between neurons, the more neurons per layer and/or the more layers of neurons, the greater the intelligence the network is capable of achieving. As such, neural networks for actual, real-world artificial intelligence applications are generally characterized by large numbers of neurons and large numbers of connections between neurons. Extremely large numbers of calculations (not only for neuron output functions but also weighted connections) are therefore involved in processing information through a neural network.

As mentioned above, although a neural network can be completely implemented in software as program code instructions that are executed on one or more traditional general purpose central processing unit (CPU) or graphics processing unit (GPU) processing cores, the read/write activity between the CPU/GPU core(s) and system memory that is needed to perform all the calculations is extremely intensive. The overhead and energy associated with repeatedly moving large amounts of read data from system memory, processing that data by the CPU/GPU cores and then writing resultants back to system memory, across the many millions or billions of computations needed to realize the neural network have not been entirely satisfactory in certain aspects.

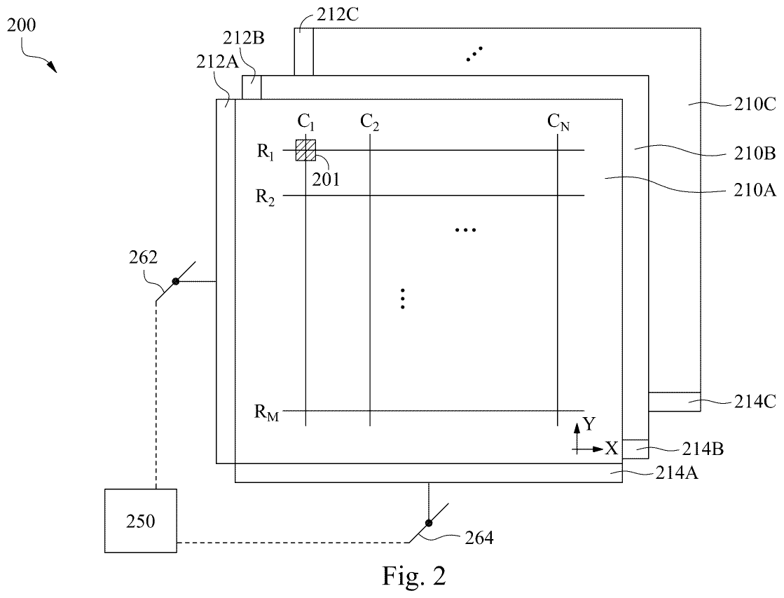

FIG. 2 illustrates a block diagram of an integrated circuit (e.g., a CiM system) 200 that can efficiently output a number of MAC values by simultaneously accessing a plural number of memory arrays formed in respectively different physical layers, in accordance with various embodiments. It should be understood that the CiM system 200 of FIG. 2 has been simplified for illustration purposes. Thus, the CiM system 200 can include any of various other components, while remaining within the scope of present disclosure. For example, the CiM system 200 may include one or more pre-charging circuits configured to pre-charge a bit line, and one or more decoder circuits configured to decode an address signal.

As shown, the CiM system 200 includes memory arrays 210A, 210B, 210C, etc., and a control circuit 250. Although 3 memory arrays are shown in the illustrated example of FIG. 2, it should be understood that the CiM system 200 can include any number of memory arrays while remaining within the scope of the present disclosure. The memory arrays 210A to 210C may be coupled to the control circuit 250 through a first global access line 262 and a second global access line 264. In various embodiments, the memory arrays 210A to 210C are disposed in respectively different physical layers.

For example, the memory array 210A may be formed in a first substrate, the memory array 210B may be formed in a second substrate, and the memory array 210C may be formed in a third substrate, where the first to third substrates may be vertically bonded to one another. In another example, the memory array 210A may be formed in a first one of a plurality of metallization layers disposed over a substrate, the memory array 210B may be formed in a second one of a plurality of metallization layers, and the memory array 210C may be formed in a third one of a plurality of metallization layers, where the first to third metallization layers may be vertically stacked on top of one another.

Each of the memory arrays 210A to 210C is a hardware component that is configured to store one or more data elements (e.g., one or more weight data elements). Using the memory array 210A as a representative example, the memory array 210A includes a plurality of memory cells (or otherwise storage units) 201. The memory array 210A includes a number of rows R₁, R₂, R₃ . . . R_{M}, each extending in a first direction (e.g., the X-direction) and a number of columns C₁, C₂, C₃ . . . C_{N}, each extending in a second direction (e.g., the Y-direction). Each of the rows and columns may include one or more conductive (e.g., metal) structures functioning as local access lines, e.g., local bit lines (BLs), local WLs (WLs), local source/select lines (SLs), etc. Each memory cell 201 is arranged in the intersection of a corresponding row and a corresponding column, and can be operated according to voltages or currents through the respective local access lines of the column and row. For example, each of the rows may include one or more corresponding local WLs, and each of the columns may include one or more corresponding local BLs.

Each of the memory cells 201 can be embodied as any of various configurations, such as a one-transistor-one-resistor (1T1R) configuration, a one-selector/switch-one-resistor (1S1R) configuration, a one-diode-one-resistor (1D1R) configuration, a single-transistor (1T) configuration, etc. For example, the memory cell 201, in the 1T1R configuration, may include the transistor implemented as a MOSFET or MESFET and the resistor implemented as a variable resistor, a magnetoresistive stack, a phase-change stack, or the like. In another example, the memory cell 201, in the 1S1R configuration, may include the selector implemented as bipolar metal-insulator-metal structure and the resistor implemented as a variable resistor, a magnetoresistive stack, a phase-change stack, or the like. In yet another example, the memory cell 201, in the 1T configuration, may include a FeFET, a floating fate flash memory structure, a SONOS memory structure, or the like, with an adjustable threshold voltage. In some other embodiments, the memory cells 201 may each be implemented as a 6-transistor (6T) static random access memory (SRAM) cell, 8-transistor (8T) SRAM cell, or 10-transistor (10T) SRAM cell. In some other embodiments, the memory cells 201 may each represent a memory cell based on a dynamic random access memory (DRAM) technology.

In various embodiments, each of the memory arrays 210A to 210C can include at least a row control circuit (e.g., 212A, 212B, 212C) and a column control circuit (e.g., 214A, 214B, 214C). The row control circuit 212A can selectively couple the first global access line 262 to one or more local access lines disposed along the rows. For example, the row control circuit 212A can include a plural number of first switches selectively connected to the local access lines (e.g., WLs) disposed along the rows, respectively. In some embodiments, the control circuit 250 can determine whether to individually activate the first switches of each of the memory arrays or simultaneously activate the first switches of all the memory arrays, based on an operation mode of the CiM system 200. The column control circuit 214A can selectively couple the second global access line 264 to one or more local access lines disposed along the columns. For example, the column control circuit 214A can include a plural number of second switches selectively connected to the local access lines (e.g., BLs) disposed along the columns, respectively. In some embodiments, the control circuit 250 can determine whether to individually activate the second switches of each of the memory arrays or simultaneously activate the second switches of all the memory arrays, based on an operation mode of the CiM system 200.

Further, as the global access lines 262 and 264 are configured to be accessible to all the memory arrays, e.g., 210A to 210C that are vertically disposed on top of one another, the global access lines 262-264 may extend in a direction perpendicular to the lengthwise or extending directions of the local access lines. For example, the local access lines (WLs, BLs) of each of the memory arrays 210A to 210C may extend in the X-direction and/or the Y-direction (or lateral directions), while the global access lines 262 to 264 may extend in the Z-direction (or a vertical direction). In certain embodiments, the memory arrays 210A to 210C may each have its local access lines extending all the way across the array in the X-direction or Y-direction. As such, in a certain operation mode (e.g., generating a MAC value), multiple memory arrays can be simultaneously accessed through the global access lines.

The control circuit 250, which may include an analog processor and an analog-to-digital converter (ADC). In some embodiments, the analog processor of the control circuit 250 can receive two at least inputs (e.g., a weight data element and an input data element) and perform one or more computations on the inputs. The computation can be matrix multiplication, absolute difference computation, dot product multiplication, or other Machine Learning (ML) operation. As such, the analog processer of the control circuit 250 can provide one or more MAC values for the received inputs, and the ADC of the control circuit 250 can convert the MAC values to digital bits.

In one aspect of the present disclosure, the control circuit 250 can simultaneously receive (e.g., retrieve) different weight data elements (or different bits of a weight data element) from the memory arrays 210A to 210C, respectively, and receive an input data element to compute one or more MAC values. The control circuit 250 can retrieve the weight data elements from different memory arrays through their respective row control circuits (e.g., 212A) and column control circuits (e.g., 214A). For example, the control circuit 250 can multiply an input data element by a first weight data element retrieved from a first one of the memory arrays 210A to 210C to generate a first product, and multiply the same input data element by a second weight data element retrieved from a second one of the memory arrays 210A to 210C to generate a second product. The control circuit 250 can retrieve the weight data elements from the respective memory arrays based on a voltage-sensing technique (e.g., detecting a voltage level presented on a BL). The control circuit 250 can then sum the first product and second product, e.g., as a partial product.

As a non-limiting example, prior to a read operation, the local access lines along the columns (e.g., BLs) across all the memory arrays 210A to 210C may be pre-charged to a supply voltage (e.g., VDD). When the control circuit 250 activates a number of rows (e.g., WLs) of the memory array 210A, at least one of the BLs of the memory array 210A may discharge to a voltage proportional to the values stored in the activated WLs. Weighting the rows by bit position weighted can result in a column voltage drop (ΔV_{BL}, or delta/change of bit line voltage) that is directly proportional to a binary stored weight data element. For a 4-bit weight data element, W₁, W₁[3] and W₁[0] may represent the MSB and the LSB of W₁, respectively. The 4 bits of W₁, W₁[3], W₁[2], W₁[1], and W₁[0] are sequentially stored in the 4^{th}, 3^{rd}, 2^{nd}, and 1^{st} WLs of the memory array 210A, respectively. The voltage drop of the BL can be proportional to {W₀+2×W₁+4×W₂+8×W₃}. The control circuit 250 can multiply an input data element XIN by such a read weight data element W₁ to generate a first product. Simultaneously, the control circuit 250 can read out another weight data element, W₂, from the memory array 210B based on the same principle, and multiply the input data element XIN by the read weight data element W₂ to generate a second product. The control circuit 250 can then sum up the first product and the second product.

In another aspect of the present disclosure, the control circuit 250 can simultaneously apply different input data elements (or different bits of an input data element) to the memory arrays 210A to 210C, respectively, and simultaneously multiply the input data elements by different weight data elements stored in the respective memory arrays to compute one or more MAC values. The control circuit 250 can apply the input data elements to different memory arrays through their respective row control circuits (e.g., 212A), and retrieve the products from the corresponding memory arrays through their column control circuits (e.g., 214A). For example, the control circuit 250 can multiply a first input data element, applied to a first one of the memory arrays 210A to 210C, by a first weight data element stored in the first memory array to generate a first product, and multiply a second input data element, applied to a second one of the memory arrays 210A to 210C, by a second weight data element stored in the second memory array to generate a second product. The control circuit 250 can retrieve the products from the respective memory arrays based on a current-sensing technique (e.g., detecting a current level presented on a BL). The control circuit 250 can then sum the first product and second product, e.g., as a partial product.

As another non-limiting example, a first weight data element, W₁, which includes a respective number of bits, can be respectively stored in one or more memory cells coupled to a first local access line (e.g., BL₁) along the columns of the memory array 210A, and a second weight data element, W₂, which includes a respective number of bits, can be respectively stored in one or more memory cells coupled to a second local access line (e.g., BL₂) along the columns of the memory array 210B. The control circuit 250, upon receiving an input data element XIN, can activate one or more local access lines along the respective rows of the memory array 210A and one or more local access lines along the respective rows of the memory array 210B. The control circuit 250 can simultaneously determine a first product (of the input data element XIN and the first weight data element W₁) based on a first current level detected through BL₁, and determine a second product (of the input data element XIN and the second weight data element W₁) based on a second current level detected through BL₂. The control circuit 250 can then sum up the first product and the second product.

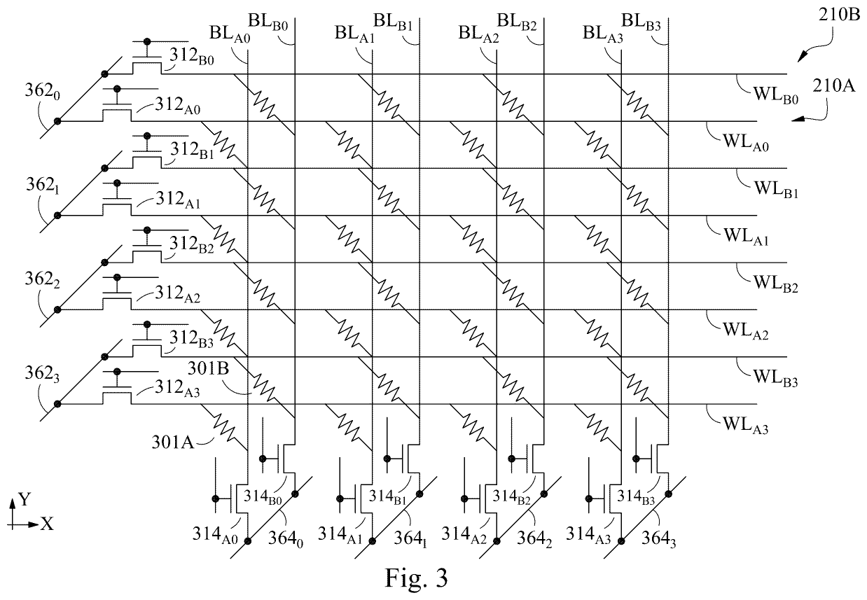

FIG. 3 illustrates a schematic diagram of a portion of the CiM system 200 that includes two memory arrays, in accordance with various embodiments of the present disclosure. In the illustrated example of FIG. 3, the memory array 210A and memory array 210B are shown. In various embodiments, the memory array 210A and memory array 210B are formed in respectively different substrates that are bonded to each other, or in respectively different (e.g., metallization) layers stacked over the same substrate.

As shown, the memory array 210A includes a number of memory cells 301A arranged over 4 local access lines extending along the X-direction (e.g., WL_{A0}, WL_{A1}, WL_{A2}, WL_{A3}) and 4 local access lines extending along the Y-direction (e.g., BL_{A0}, BL_{A1}, BL_{A2}, BL_{A3}). Each of the memory cells 301A is coupled to (e.g., accessed through) a corresponding one of WL₀ to WL₄ and a corresponding one of BL₀ to BL₄. Similarly, the memory array 210B includes a number of memory cells 301B arranged over 4 local access lines extending along the X-direction (e.g., WL_{B0}, WL_{B1}, WL_{B2}, WL_{B3}) and 4 local access lines extending along the Y-direction (e.g., BL_{B0}, BL_{B1}, BL_{B2}, BL_{B3}). Each of the memory cells 301B is coupled to (e.g., accessed through) a corresponding one of WL_{B0} to WL_{B4} and a corresponding one of BL_{B0} to BL_{B4}.

Further, the row control circuit 212A of the memory array 210A includes a number of switches 312_{A0}, 312_{A1}, 312_{A2}, and 312_{A3} coupled to WL_{A0}, WL_{A1}, WL_{A2}, WL_{A3}, respectively, and the column control circuit 214A of the memory array 210A includes a number of switches 314_{A0}, 314_{A1}, 314_{A2}, and 314_{A3} coupled to BL_{A0}, BL_{A1}, BL_{A2}, BL_{A3}, respectively. Similarly, the row control circuit 212B of the memory array 210B includes a number of switches 312_{B0}, 312_{B1}, 312_{B2}, and 312_{B3} coupled to WL_{B0}, WL_{B1}, WL_{B2}, WL_{B3}, respectively, and the column control circuit 214B of the memory array 210B includes a number of switches 314_{B0}, 314_{B1}, 314_{B2}, and 314_{B3} coupled to BL_{B0}, BL_{B1}, BL_{B2}, BL_{B3}, respectively. The switches, 312 and 314, can each include a pass gate, an n-type metal-oxide-semiconductor (NMOS) transistor, a p-type metal-oxide-semiconductor (PMOS) transistor, or the like.

In various embodiments, each of the switches, 312 and 314, is configured to selectively couple a corresponding local access line to a global access line, based on a control signal. Such a control signal can be provided by the control circuit 250 according to at least one of an operation mode of the corresponding memory array, the address of an activated memory cell to be programmed or read, or a conductive type of the switch. Further, the global access line may each have at least a portion (e.g., implemented as a via structure, a through-silicon via structure, a through-substrate via structure, or the like) extending in a direction perpendicular to the extending directions of the local access lines, in various embodiments of the present disclosure. As such, such global access lines can be shared by the memory arrays formed in respectively different layers or substrates.

For example, in the memory array 210A, the switch 312_{A0} can selectively couple WL_{A0} to a global WL 362₀; the switch 312_{A1} can selectively couple WL_{A1} to a global WL 362₁; the switch 312_{A2} can selectively couple WL_{A2} to a global WL 362₂; the switch 312_{A3} can selectively couple WL_{A3} to a global WL 362₃; the switch 314_{A0} can selectively couple BL_{A0} to a global BL 364₀; the switch 314_{A1} can selectively couple BL_{A1} to a global BL 364₁; the switch 314_{A2} can selectively couple BL_{A2} to a global BL 364₂; and the switch 314_{A3} can selectively couple BL_{A3} to a global BL 364₃. Similarly, in the memory array 210B, the switch 312_{B0} can selectively couple WL_{B0} to the global WL 362₀; the switch 312_{B1} can selectively couple WL_{B1} to the global WL 362₁; the switch 312_{B2} can selectively couple WL_{B2} to the global WL 362₂; the switch 312_{B3} can selectively couple WL_{B3} to the global WL 362₃; the switch 314_{B0} can selectively couple BL_{B0} to the global BL 364₀; the switch 314_{B1} can selectively couple BL_{B1} to the global BL 364₁; the switch 314_{B2} can selectively couple BL_{B2} to the global BL 364₂; and the switch 314_{B3} can selectively couple BL_{B3} to the global BL 364₃.

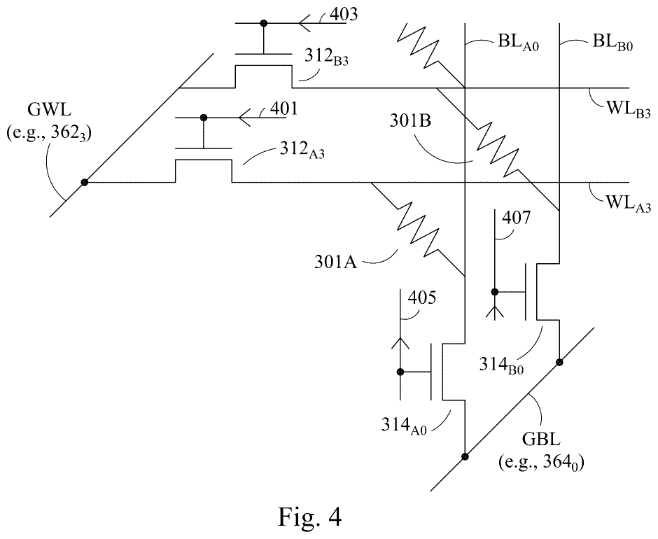

FIG. 4 illustrates an example implementation of a portion of the memory array 210A and a portion of the memory array 210B of the schematic diagram shown in FIG. 3, in accordance with some embodiments. As shown, the memory cell 301A (of the memory array 210A) connected to WL_{A3} and BL_{A0} and the memory cell 301B (of the memory array 210B) connected to WL_{B3} and BL_{B0} are shown. Specifically, the WL_{A3} and WL_{B3} (of the memory arrays 210A and 210B) can be commonly coupled to the global WL 362₃ through the switches 312_{A3} and 312_{B3}, respectively; and the BL_{A0} and BL_{B0} (of the memory arrays 210A and 210B) can be commonly coupled to the global BL 364₀ through the switches 314_{A0} and 314_{B0}, respectively. The switches 312_{A3}, 312_{B3}, 314_{A0}, and 314_{B0} can each be implemented as an NOMS transistor.

In the implementation of FIG. 4, the switches 312_{A3}, 312_{B3}, 314_{A0}, and 314_{B0} can be controlled (e.g., activated or deactivated) by control signals, 401, 403, 405, and 407, respectively. Such control signals 401 to 407 can be provided by the control circuit 250 to the memory arrays 210A-B through respective control lines. These control lines, coupled to the control circuit 250, can each be arranged in parallel with the corresponding controlled local access line. For example, the control line conducting the control signal 401 may extend in parallel with WL_{A3}; and the control line conducting the control signal 405 may extend in parallel with BL_{A0}. According to various embodiments of the present disclosure, during a program operation performed on the memory cells 301A-B, one of the switch 312_{A3} or the switch 312_{B3} can be activated; and during a computation (e.g., MAC) operation performed on the memory cells 301A-B, both of the switch 312_{A3} and the switch 312_{B3} can be activated.

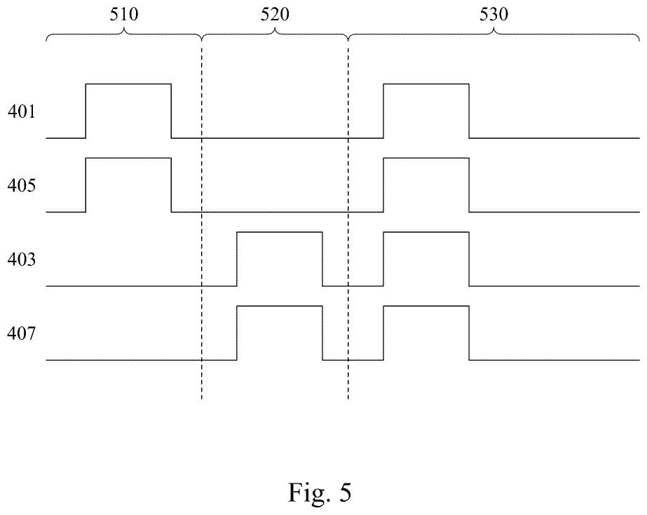

FIG. 5 illustrates example waveforms of the control signals 401, 403, 405, and 407 during various operations modes of the memory cells 301A-B (or more generally, the operations modes of the memory arrays 210A-B), respectively, in accordance with some embodiments. As shown, during a first time period 510 in which one or more memory cells 301A of the memory array 210A are configured to be programmed (e.g., writing one or more weight data elements into those memory cells 301A), the control signals 401 and 405 are pulled up to a logic high state, while the control signals 403 and 407 remain at (or transition to) a logic low state. During a second time period 520 in which one or more memory cells 301B of the memory array 210B are configured to be programmed (e.g., writing one or more weight data elements into those memory cells 301B), the control signals 403 and 407 are pulled up to a logic high state, while the control signals 401 and 405 remain at (or transition to) a logic low state. During a third time period 530 in which the programmed data elements are configured to be read out (e.g., for performing a MAC operation), all the control signals 401 to 407 are pulled up to a logic high state.

As such, during time period 510, the control circuit 250 can write a first data element into one or more memory cells 301A of the memory array 210A; during time period 520, the control circuit 250 can write a second data element into one or more memory cells 301B of the memory array 210B; and during time period 530, the control circuit 250 can simultaneously multiply a third data element by the first data element (retrieved from the memory array 210A) and by the second data element (retrieved from the memory array 210B). In some embodiments, the time period 530 may occur after any of the time period 510 or time period 520, but the order of the time period 510 and time period 520 can be arbitrarily changed.

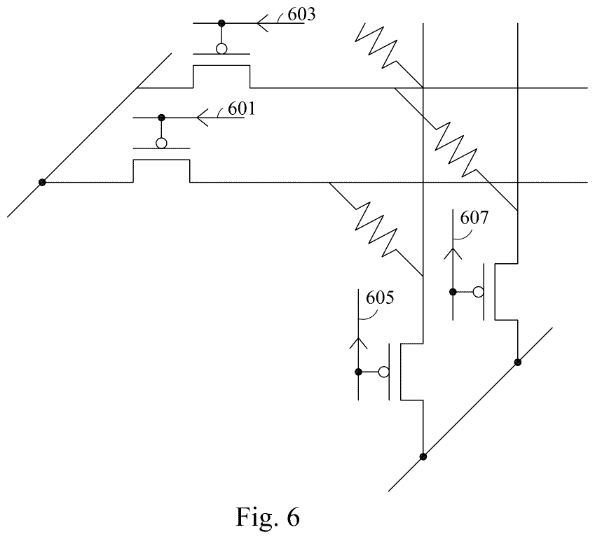

FIG. 6 illustrates another example implementation of a portion of the memory array 210A and a portion of the memory array 210B of the schematic diagram shown in FIG. 3, in accordance with some embodiments. As shown, the memory cell 301A (of the memory array 210A) connected to WL_{A3} and BL_{A0} and the memory cell 301B (of the memory array 210B) connected to WL_{B3} and BL_{B0} are shown. Specifically, the WL_{A3} and WL_{B3} (of the memory arrays 210A and 210B) can be commonly coupled to the global WL 362₃ through the switches 31243 and 312_{B3}, respectively; and the BL_{A0} and BL_{B0} (of the memory arrays 210A and 210B) can be commonly coupled to the global BL 364₀ through the switches 314_{A0} and 314_{B0}, respectively. The switches 312_{A3}, 312_{B3}, 314_{A0}, and 314_{B0} can each be implemented as a POMS transistor.

In the implementation of FIG. 6, the switches 312_{A3}, 312_{B3}, 314_{A0}, and 314_{B0} can be controlled (e.g., activated or deactivated) by control signals, 601, 603, 605, and 607, respectively. Such control signals 601 to 607 can be provided by the control circuit 250 to the memory arrays 210A-B through respective control lines. These control lines, coupled to the control circuit 250, can each be arranged in parallel with the corresponding controlled local access line. For example, the control line conducting the control signal 601 may extend in parallel with WL_{A3}; and the control line conducting the control signal 605 may extend in parallel with BL_{A0}. According to various embodiments of the present disclosure, during a program operation performed on the memory cells 301A-B, one of the switch 312_{A3} or the switch 312_{B3} can be activated; and during a computation (e.g., MAC) operation performed on the memory cells 301A-B, both of the switch 312_{A3} and the switch 312_{B3} can be activated.

FIG. 7 illustrates example waveforms of the control signals 601, 603, 605, and 607 during various operations modes of the memory cells 301A-B (or more generally, the operations modes of the memory arrays 210A-B), respectively, in accordance with some embodiments. As shown, during a first time period 710 in which one or more memory cells 301A of the memory array 210A are configured to be programmed (e.g., writing one or more weight data elements into those memory cells 301A), the control signals 601 and 605 are pulled down to a logic low state, while the control signals 603 and 607 remain at (or transition to) a logic high state. During a second time period 720 in which one or more memory cells 301B of the memory array 210B are configured to be programmed (e.g., writing one or more weight data elements into those memory cells 301B), the control signals 603 and 607 are pulled down to a logic low state, while the control signals 601 and 605 remain at (or transition to) a logic high state. During a third time period 730 in which the programmed data elements are configured to be read out (e.g., for performing a MAC operation), all the control signals 601 to 607 are pulled down to a logic low state.

As such, during time period 710, the control circuit 250 can write a first data element into one or more memory cells 301A of the memory array 210A; during time period 720, the control circuit 250 can write a second data element into one or more memory cells 301B of the memory array 210B; and during time period 730, the control circuit 250 can simultaneously multiply a third data element by the first data element (retrieved from the memory array 210A) and by the second data element (retrieved from the memory array 210B). In some embodiments, the time period 730 may occur after any of the time period 710 or time period 720, but the order of the time period 710 and time period 720 can be arbitrarily changed.

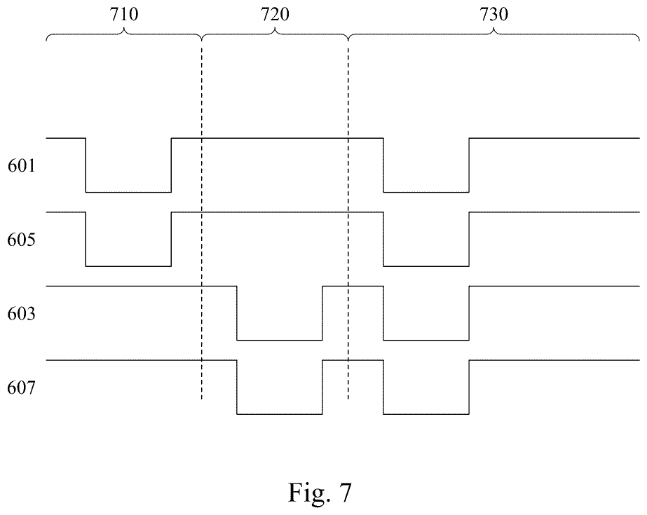

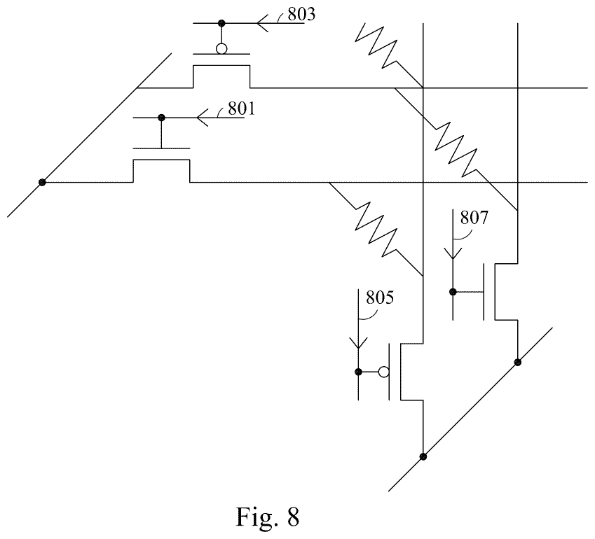

FIG. 8 illustrates yet another example implementation of a portion of the memory array 210A and a portion of the memory array 210B of the schematic diagram shown in FIG. 3, in accordance with some embodiments. As shown, the memory cell 301A (of the memory array 210A) connected to WL_{A3} and BL_{A0} and the memory cell 301B (of the memory array 210B) connected to WL_{B3} and BL_{B0} are shown. Specifically, the WL_{A3} and WL_{B3} (of the memory arrays 210A and 210B) can be commonly coupled to the global WL 362₃ through the switches 312_{A3} and 312_{B3}, respectively; and the BL_{A0} and BL_{B0} (of the memory arrays 210A and 210B) can be commonly coupled to the global BL 364₀ through the switches 314_{A0} and 314_{B0}, respectively. The switches 312_{A3} and 312_{B3} can be implemented as an NMOS transistor and a POMS transistor, respectively; and the switches 314_{A0} and 314_{B0} can be implemented as a PMOS transistor and an NMOS transistor, respectively.

In the implementation of FIG. 9, the switches 312_{A3}, 312_{B3}, 314_{A0}, and 314_{B0} can be controlled (e.g., activated or deactivated) by control signals, 801, 803, 805, and 807, respectively. Such control signals 801 to 807 can be provided by the control circuit 250 to the memory arrays 210A-B through respective control lines. These control lines, coupled to the control circuit 250, can each be arranged in parallel with the corresponding controlled local access line. For example, the control line conducting the control signal 801 may extend in parallel with WL_{A3}; and the control line conducting the control signal 805 may extend in parallel with BL_{A0}. According to various embodiments of the present disclosure, during a program operation performed on the memory cells 301A-B, one of the switch 312_{A3} or the switch 312_{B3} can be activated; and during a computation (e.g., MAC) operation performed on the memory cells 301A-B, both of the switch 312_{A3} and the switch 312_{B3} can be activated.

FIG. 9 illustrates example waveforms of the control signals 801, 803, 805, and 807 during various operations modes of the memory cells 301A-B (or more generally, the operations modes of the memory arrays 210A-B), respectively, in accordance with some embodiments. As shown, during a first time period 910 in which one or more memory cells 301A of the memory array 210A are configured to be programmed (e.g., writing one or more weight data elements into those memory cells 301A), the control signals 801 and 805 are pulled up to a logic high state and pulled down to a logic low state, respectively, while the control signals 803 and 807 remain at (or transition to) a logic high state and a logic low state, respectively. During a second time period 920 in which one or more memory cells 301B of the memory array 210B are configured to be programmed (e.g., writing one or more weight data elements into those memory cells 301B), the control signals 803 and 807 are pulled down to a logic low state and pulled up to a high logic state, respectively, while the control signals 801 and 805 remain at (or transition to) a logic high state and a logic low state, respectively. During a third time period 930 in which the programmed data elements are configured to be read out (e.g., for performing a MAC operation), the control signals 801, 803, 805, and 807 are set at a logic high state, a logic low state, a logic low state, and a logic high state, respectively.

As such, during time period 910, the control circuit 250 can write a first data element into one or more memory cells 301A of the memory array 210A; during time period 920, the control circuit 250 can write a second data element into one or more memory cells 301B of the memory array 210B; and during time period 930, the control circuit 250 can simultaneously multiply a third data element by the first data element (retrieved from the memory array 210A) and by the second data element (retrieved from the memory array 210B). In some embodiments, the time period 930 may occur after any of the time period 910 or time period 920, but the order of the time period 910 and time period 920 can be arbitrarily changed.

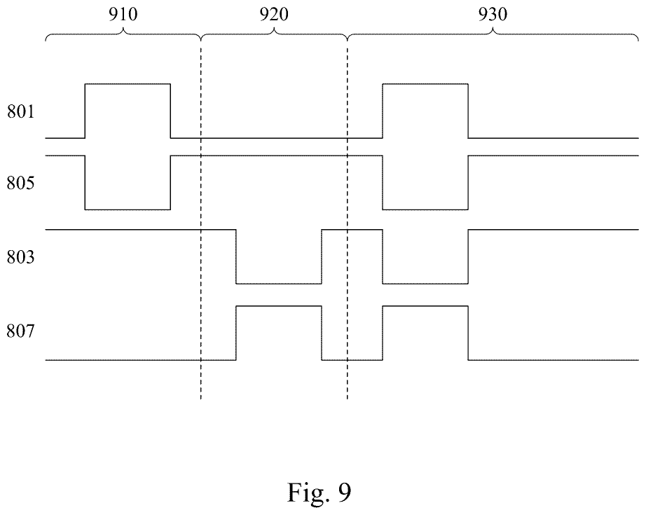

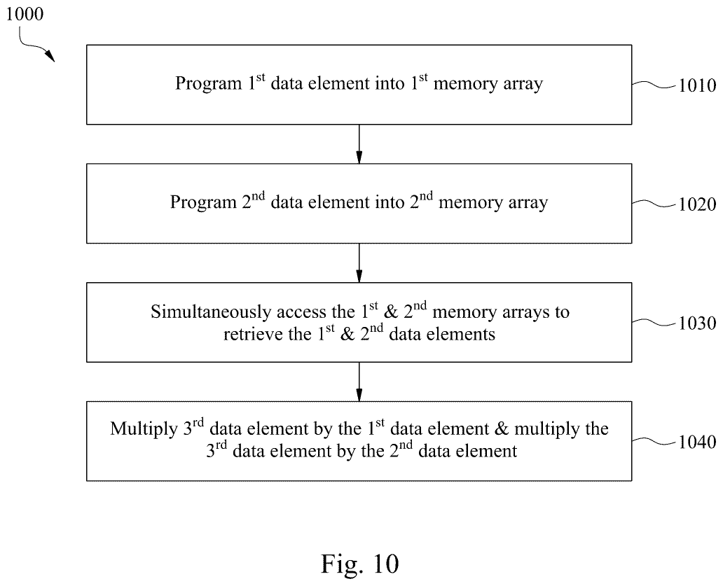

FIG. 10 illustrates a flow chart of an example method 1000 for operating a CiM system including a plural number of memory arrays stacked on top of one another, in accordance with various embodiments of the present disclosure. The operations of the method 1000 may be performed by the components described above (e.g., FIGS. 2-9), and thus, some of the reference numerals used above may be re-used the following discussion of the method 1000. Further, it is understood that the method 1000 has been simplified, and thus, additional operations may be provided before, during, and after the method 1000 of FIG. 10, and that some other operations may only be briefly described herein.

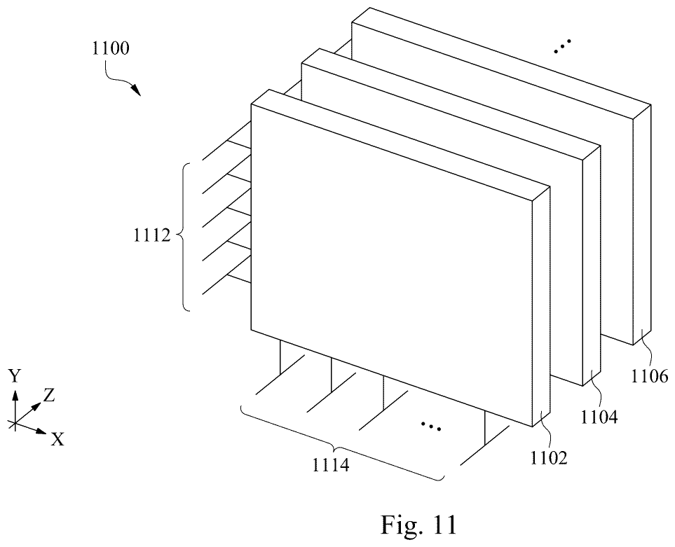

The method 1000 starts with operation 1010 of programming a first data element into a first memory array. In some embodiments, the first data element may correspond to a first weight data element or a first subset of bits of a weight data element. The first memory array can include a plural number of first memory cells formed in a first physical layer, or a first memory array layer which will be discussed below in FIGS. 11-15. To program the first data element into the first memory array (e.g., 210A), a control circuit (e.g., 250) can activate the first memory array's row control circuit (e.g., 212A) and column control circuit (e.g., 214A) to couple one or more of its local access lines (e.g., BLs, WLs) to respective global access lines (e.g., 262, 264), which allows the control circuit 250 to write the first data element into the first memory array 210A through its row control circuit 212A and column control circuit 214A.

The method 1000 continues to operation 1020 of programming a second data element into a second memory array. In some embodiments, the second data element may correspond to a second weight data element or a second subset of bits of the weight data element. The second memory array can include a plural number of second memory cells formed in a second physical layer, or a second memory array layer which will be discussed below in FIGS. 11-15. To program the second data element into the second memory array (e.g., 210B), the control circuit 250 can activate the second memory array's row control circuit (e.g., 212B) and column control circuit (e.g., 214B) to couple one or more of its local access lines (e.g., BLs, WLs) to respective global access lines (e.g., 262, 264), which allows the control circuit 250 to write the second data element into the second memory array 210B through its row control circuit 212B and column control circuit 214B. In various embodiments of the present disclosure, the control circuit 250 may individually program the data element into a corresponding memory array. For example, the first and second data elements may be written into respective memory arrays during different time periods.

The method 1000 continues to operation 1030 of simultaneously accessing the first memory array and the second memory array to retrieve the first and second data elements. Continuing with the above example, after the first data element and second data element are written into the respective memory arrays, 210A and 210B, the control circuit 250 can simultaneously access the memory arrays 210A and 210B to retrieve the first data element and second data element, respectively. For example, the control circuit 250 can active the row control circuit 212A and the column control circuit 214A to couple the global access line 262 and 264 to the memory array 210A; and concurrently, the control circuit 250 can active the row control circuit 212B and the column control circuit 214B to couple the global access line 262 and 264 to the memory array 210B.

The method 1000 continues to operation 1040 of multiplying a third data element by the first data element and multiplying the third data element by the second data element. Continuing with the above example, the control circuit 250 can multiply the third data element (e.g., an input data element) by the retrieved first data element and multiply the third data element by the retrieved second data element. In one aspect, the control circuit 250 may receive the third data element and perform the multiplications (e.g., within the control circuit 250). In another aspect, the control circuit 250 may receive the third data element, apply the third data element to both of the first and second memory arrays, and perform the multiplications (e.g., within the respective memory arrays). After performing the multiplications, the control circuit 250 can sum up the first product (of the first and third data elements) and the second product (of the second and third data elements).

FIG. 11 illustrates a perspective view of an example memory system 1100 including a number of first interconnect structures 1112 and a number of second interconnect structures 1114 configured to operatively couple one physical layer to one or more other physical layers that are integrated (e.g., stacked) on top of one another in the Z-direction, in accordance with various embodiments. The memory system 1100 may include substantially similar components as the memory system discussed above, e.g., 200 of FIG. 2. It should be understood that the configuration of memory system 1100 shown in FIG. 11 has been simplified for illustration purposes, and thus, the memory system 1100 can include any of various other layers and/or have different configurations (e.g., different layers coupled to each other, depending on desired designs, etc.), while remaining within the scope of the present disclosure.

As shown, the memory system 1100 includes at least one peripheral layer 1102, and a plural number of memory array layers 1104 and 1106 disposed above the peripheral layer 1102. According to some embodiments of the present disclosure, the peripheral layer 1102, and the memory array layers 1104 to 1106 may be formed in respectively different substrates (e.g., wafers). As such, the peripheral layer 1102 can be operatively coupled to one or more of the memory array layers 1104 to 1106 through one or more of the first and second interconnect structures 1112 and 1114, at least a portion of which may be implemented as a through-silicon/substrate via (TSV) structure. Alternatively stated, each of the first and second interconnect structures 1112 and 1114 may be selectively coupled to one or more of the memory array layers 1104 to 1106 based on their configured operation modes. According to some other embodiments of the present disclosure, the peripheral layer 1102, and the memory array layers 1104 to 1106 may be formed in respectively different layers but all disposed on a same substrate (e.g., wafer). As such, the peripheral layer 1102 can be operatively coupled to one or more of the memory array layers 1104 to 1106 through one or more of the first and second interconnect structures 1112 and 1114, at least a portion of which may be implemented as a via structure.

For example, the peripheral layer 1102 can include a number of components operatively serve as a control circuit (e.g., 250), which can include an input/output (I/O) circuit, a logic control circuit, a command register, an address register, and a sequencer, while the memory array layers 1104 to 1106 can each include a memory array (e.g., 210A-C) and corresponding row/column control circuits (e.g., 212A-C, 214A-C). In general, the I/O circuit is configured to communicate various I/O signals (e.g., a command (CMD) signal, an address information (ADD) signal, and a data (DAT) signal) with a memory controller which may also be formed in the peripheral layer 1102. When the I/O signal is received from the memory controller, the I/O circuit can distribute the I/O signal to the CMD signal, ADD signal, and DAT signal based on information received from a logic control circuit which may also be formed in the peripheral layer 1102. The I/O circuit provides the CMD signal to the command register and the ADD signal to the address register, respectively. Further, the I/O circuit communicates the DAT signal with a sensing amplifier. The logic control circuit is configured to receive CLE, ALE, Wen, and Ren signals from the memory controller. The logic control circuit can send out the above-mentioned information to the I/O circuit for identifying the CMD signal, the ADD signal, and the DAT signal in the I/O signal. In addition, the logic control circuit provides the RBn signal to the memory controller to notify the state of a corresponding memory device. The command register is configured to store the CMD received from the I/O circuit. The CMD includes, for example, an instruction for causing the sequencer to execute a read operation, a write operation, an erasing operation, or the like. The address register is configured to store the address information ADD received from the I/O circuit. The ADD at least includes, for example, a row address (RAd) and a column address (CAd). The row address RAd and the column address CAd may be used to select a word line and a bit line, respectively. The sequencer is configured to control an operation of the entire memory device. For example, the sequencer can control a row control circuit (e.g., 212A-C shown in FIG. 2), a column control circuit (e.g., 214A-C shown in FIG. 2), or the like based on the CMD stored in the command register, and execute a read operation, a write operation, an erasing operation, a computation operation, or the like.

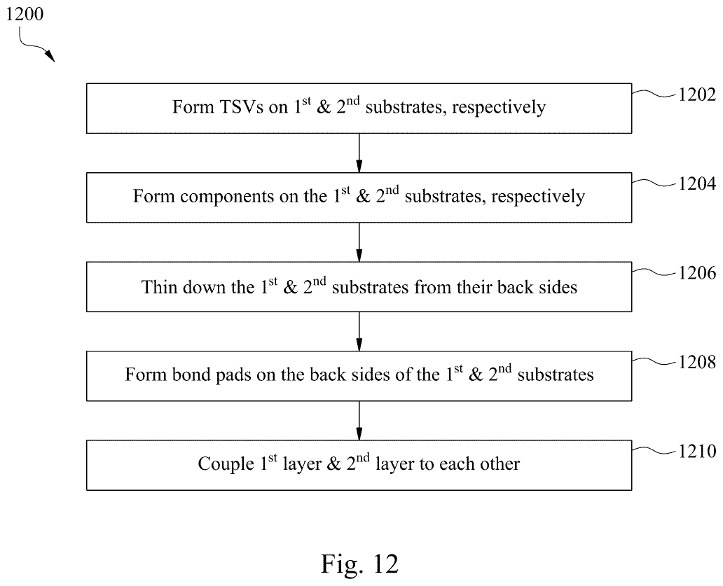

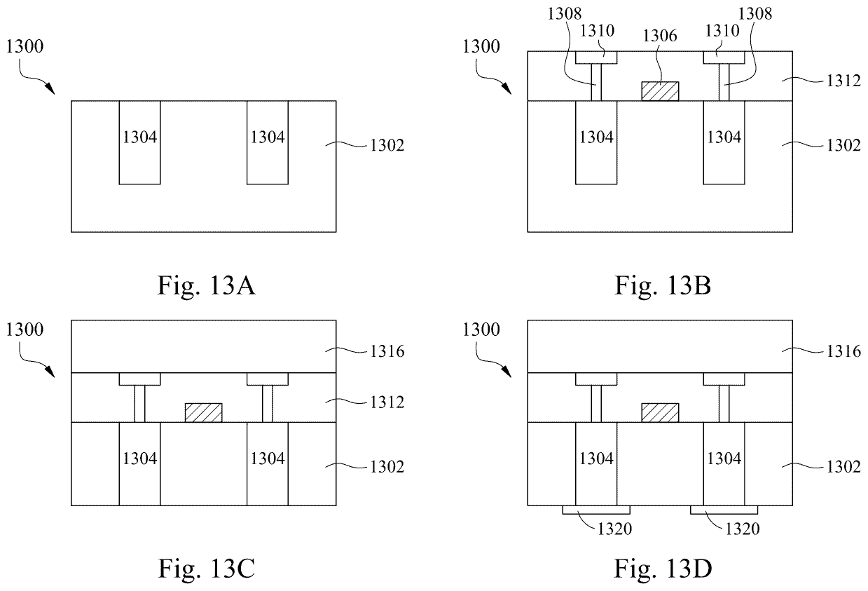

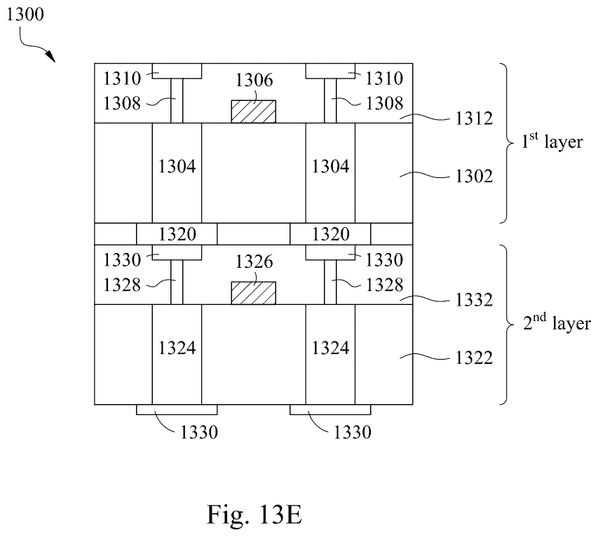

FIG. 12 illustrates a flowchart of a method 1200 to form a memory system including different layers operatively coupled to each other through TSVs, according to one or more embodiments of the present disclosure. For example, at least some of the operations (or steps) of the method 1200 can be used to form a memory system discussed above. It is noted that the method 1200 is merely an example, and is not intended to limit the present disclosure. Accordingly, it should be understood that additional operations may be provided before, during, and/or after the method 1200 of FIG. 12, and that some other operations may only be briefly described herein. In some embodiments, operations of the method 1200 may be associated with cross-sectional views of an example semiconductor device at various fabrication stages as shown in FIGS. 13A, 13B, 13C, 13D, and 13E, respectively, which will be discussed in further detail below.

Corresponding to operation 1202 of FIG. 12, FIG. 13A illustrates a cross-sectional view of a portion of a semiconductor device 1300 including a first substrate (or chip) 1302 with a number of TSVs 1304 formed over a front surface of the first substrate 1302 at one of the various stages of fabrication, in accordance with various embodiments.

The first substrate 1302 may be a semiconductor substrate, such as a bulk semiconductor, a semiconductor-on-insulator (SOI) substrate, or the like, which may be doped (e.g., with a p-type or an n-type dopant) or undoped. The first substrate 1302 may be a wafer, such as a silicon wafer. Generally, an SOI substrate includes a layer of a semiconductor material formed on an insulator layer. The insulator layer may be, for example, a buried oxide (BOX) layer, a silicon oxide layer, or the like. The insulator layer is provided on a substrate, typically a silicon or glass substrate. Other substrates, such as a multi-layered or gradient substrate may also be used. In some embodiments, the semiconductor material of the substrate 1302 may include silicon; germanium; a compound semiconductor including silicon carbide, gallium arsenic, gallium phosphide, indium phosphide, indium arsenide, and/or indium antimonide; an alloy semiconductor including SiGe, GaAsP, AlInAs, AlGaAs, GaInAs, GaInP, and/or GaInAsP; or combinations thereof.

The TSV 1304 is formed of a conductive material. The conductive material may comprise copper, although other suitable materials such as aluminum, alloys, doped polysilicon, combinations thereof, and the like, may alternatively be utilized. At this fabrication stage, the TSV 1304 may not completely extend through the first substrate 1302, i.e., not extending from the front surface to back surface of the first substrate 1302. The TSV 1304 may be forming by performing at least some of the following processes: forming an opening through the front surface of the first substrate 1302; lining the opening with a barrier layer (not shown); filling the opening with the above-mentioned conductive material; and polishing the first substrate 1302. Although not shown, it should be noted that the same processes to form the TSV 1304 (and the following operations of FIG. 12 except for operation 1210) can be concurrently performed on a second substrate (chip) of the semiconductor device 1300.

Corresponding to operation 1204 of FIG. 12, FIG. 13B illustrates a cross-sectional view of a portion of the semiconductor device 1300 including a number of components 1306, 1308, and 1310 formed over the front surface of the substrate 1302 at one of the various stages of fabrication, in accordance with various embodiments.

In the illustrated example of FIG. 13B (and the following figures), the component 1306 can represent a number of devices such as, for example, transistors, memory cells, etc.; the component 1308 can represent a number of via structures electrically coupled to the TSVs 1304 (and the component 1306), respectively; and the component 1310 can represent a number of interconnect structures electrically coupled to the via structures 1308, respectively. Such components 1306 to 1310 may be overlaid by a dielectric layer 1312, typically referred to as an inter-layer dielectric (ILD) or inter-metal dielectric (IMD). Upon forming such components, one of the above-discussed memory array layer or peripheral layer may have been formed, in accordance with some embodiments. For example, for a memory array layer, the component 1306 can represent: (i) a number of memory cells collectively functioning as one or more memory arrays (e.g., one of 210A to 210C); and (ii) a number of transistors collectively functioning as one or more corresponding essential circuits (e.g., one of 212A to 212C, and one of 214A to 214C). The components 1308 and 1310 can represent: (i) a number of local access lines (e.g., bit lines, word lines, etc.) of the memory arrays; and (ii) a number of interconnect structures coupled to the memory arrays.

Corresponding to operation 1206 of FIG. 12, FIG. 13C illustrates a cross-sectional view of a portion of the semiconductor device 1300 in which the first substrate 1302 is thinned down from its back surface at one of the various stages of fabrication, in accordance with various embodiments. As shown, the first substrate 1302 is thinned down from its back surface until a bottom surface of the TSV 1304 is exposed. In some embodiments, the first substrate 1302 may be thinned down using a polishing process (e.g., a chemical-mechanical polishing (CMP) process), while having its front surface coupled to a carrier wafer 1316.

Corresponding to operation 1208 of FIG. 12, FIG. 13D illustrates a cross-sectional view of a portion of the semiconductor device 1300 including a number of bonding pads 1320 coupled to the TSVs 1304, respectively, at one of the various stages of fabrication, in accordance with various embodiments. Upon the bottom surface of the TSV 1304 being exposed, the bonding pad 1320 is formed to electrically couple to the TSV 1304, thereby allowing the TSV 1304 to be electrically coupled to other components, as will be discussed as follows. The bonding pad 1320 is formed of a conductive material. The conductive material may comprise copper, although other suitable materials such as aluminum, alloys, doped polysilicon, combinations thereof, and the like, may alternatively be utilized.

Corresponding to operation 1210 of FIG. 12, FIG. 13E illustrates a cross-sectional view of a portion of the semiconductor device 1300 including a first layer and a second layer bonded to each other at one of the various stages of fabrication, in accordance with various embodiments. As mentioned above, the operations 1202 to 1208 can be concurrently performed on a second substrate (chip), which results in a similar layer being formed. As shown in FIG. 13E, after forming the bonding pads 1320, a first layer (which can be one of the above-described memory array layer or peripheral layer) is bonded to a second layer (which can be one of the above-described memory array layer or peripheral layer). Similar to the first layer, the second layer includes a thinned substrate 1322, one or more TSVs 1324 extending through the thinned substrate 1322, components 1326, 1328, and 1330, an ILD/IMD 1332, and one or more bonding pads 1330. In the illustrated example of FIG. 13E, the first layer is bonded (e.g., operatively coupled) to the second layer through the TSVs 1304. It should be appreciated that each of the first and second layers can be coupled to one or more other layers through its respective TSVs to form one of the memory systems, as discussed above.

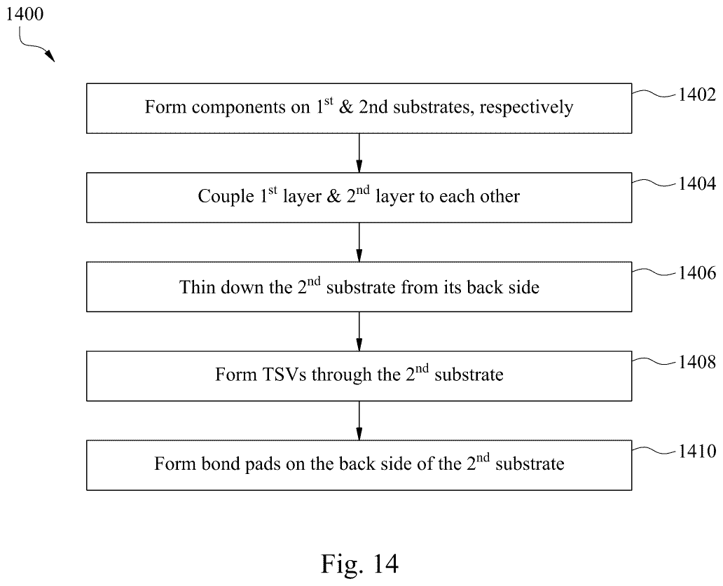

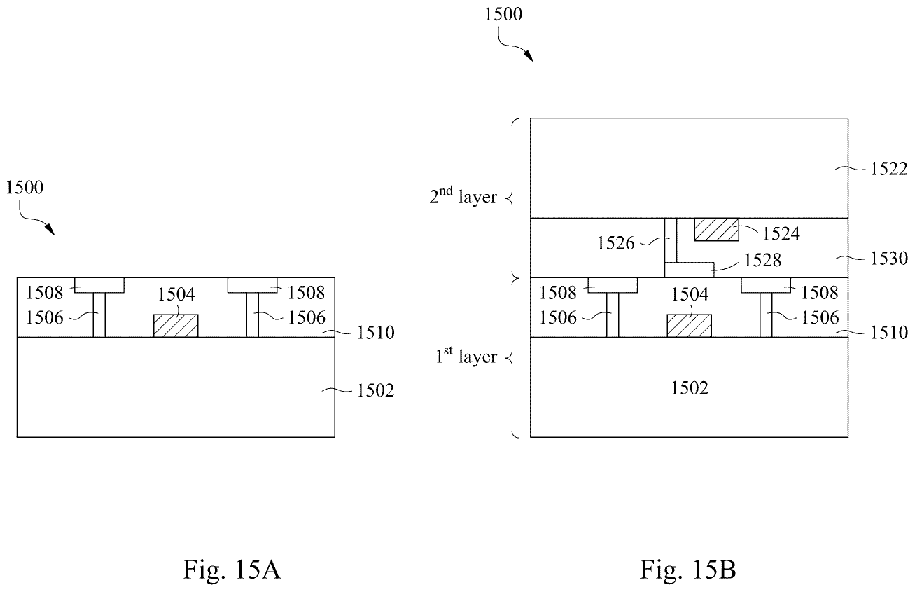

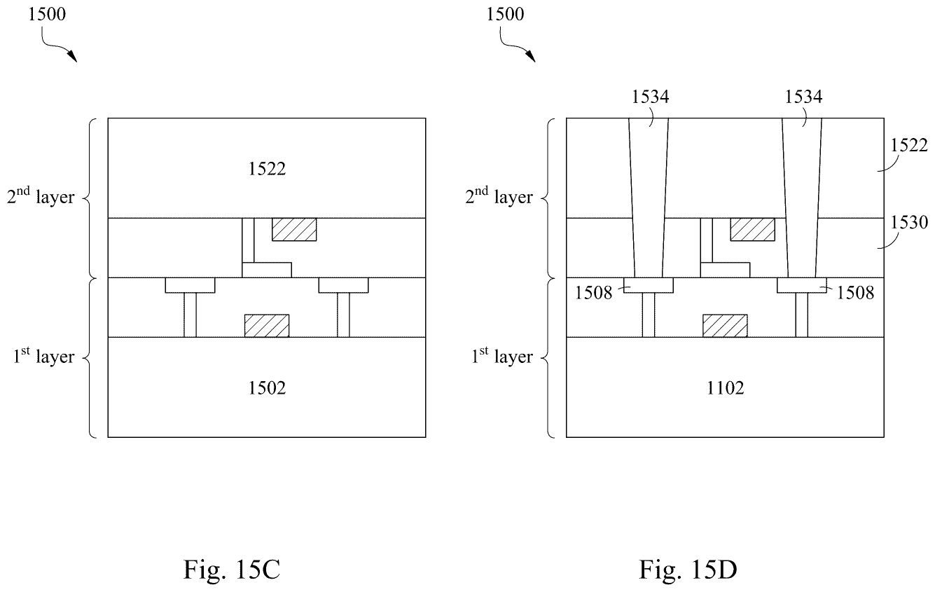

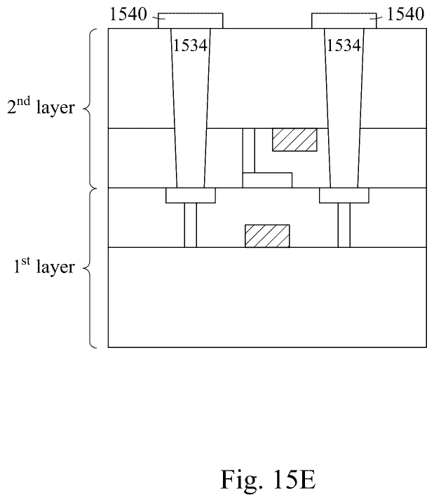

FIG. 14 illustrates a flowchart of a method 1400 to form a memory system including different layers operatively coupled to each other through TSVs, according to one or more embodiments of the present disclosure. For example, at least some of the operations (or steps) of the method 1400 can be used to form a memory system discussed above. It is noted that the method 1400 is merely an example, and is not intended to limit the present disclosure. Accordingly, it should be understood that additional operations may be provided before, during, and/or after the method 1400 of FIG. 14, and that some other operations may only be briefly described herein. In some embodiments, operations of the method 1400 may be associated with cross-sectional views of an example semiconductor device at various fabrication stages as shown in FIGS. 15A, 15B, 15C, 15D, and 15E, respectively, which will be discussed in further detail below.

Corresponding to operation 1402 of FIG. 14, FIG. 15A illustrates a cross-sectional view of a portion of a semiconductor device 1500 including a first substrate (or chip) 1502 with a number of components 1504, 1506, and 1508 formed over a front surface of the first substrate 1502 at one of the various stages of fabrication, in accordance with various embodiments.

The first substrate 1502 may be a semiconductor substrate, such as a bulk semiconductor, a semiconductor-on-insulator (SOI) substrate, or the like, which may be doped (e.g., with a p-type or an n-type dopant) or undoped. The first substrate 1502 may be a wafer, such as a silicon wafer. Generally, an SOI substrate includes a layer of a semiconductor material formed on an insulator layer. The insulator layer may be, for example, a buried oxide (BOX) layer, a silicon oxide layer, or the like. The insulator layer is provided on a substrate, typically a silicon or glass substrate. Other substrates, such as a multi-layered or gradient substrate may also be used. In some embodiments, the semiconductor material of the substrate 1502 may include silicon; germanium; a compound semiconductor including silicon carbide, gallium arsenic, gallium phosphide, indium phosphide, indium arsenide, and/or indium antimonide; an alloy semiconductor including SiGe, GaAsP, AlInAs, AlGaAs, GaInAs, GaInP, and/or GaInAsP; or combinations thereof.

In the illustrated example of FIG. 15A (and the following figures), the component 1504 can represent a number of devices such as, for example, transistors, memory cells, etc.; the component 1506 can represent a number of via structures electrically coupled to the component 1504; and the component 1508 can represent a number of interconnect structures electrically coupled to the via structures 1506, respectively. Such components 1504 to 1508 may be overlaid by a dielectric layer 1510, typically referred to as an inter-layer dielectric (ILD) or inter-metal dielectric (IMD). Upon forming such components, one of the above-discussed memory array layer or peripheral layer may have been formed, in accordance with some embodiments. For example, for a memory array layer, the component 1504 can represent: (i) a number of memory cells collectively functioning as one or more memory arrays (e.g., one of 210A to 210C); and (ii) a number of transistors collectively functioning as one or more essential circuits (e.g., one of 212A to 212C and one of 214A to 214C). The components 1306 and 1308 can represent: (i) a number of local access lines (e.g., bit lines, word lines, etc.) of the memory arrays; and (ii) a number of interconnect structures coupled to the memory arrays. It should be noted that the same processes to form the components 1504 to 1508 can be concurrently performed on a second substrate (chip) of the semiconductor device 1500, which will be shown as follows.

Corresponding to operation 1404 of FIG. 14, FIG. 15B illustrates a cross-sectional view of a portion of a semiconductor device 1500 including a first layer and a second layer bonded to each other at one of the various stages of fabrication, in accordance with various embodiments. As shown in FIG. 15B, a first layer including the first substrate 1502 and components 1504 to 1508 (which can be one of the above-described memory array layer or peripheral layer) is bonded to a second layer (which can be one of the above-described memory array layer or peripheral layer). Similar to the first layer, the second layer includes a (second) substrate 1522, components 1524, 1526, and 1528, and an ILD/IMD 1530. In the illustrated example of FIG. 15B, the second layer is bonded to the first layer by being flipped upside down.

Corresponding to operation 1406 of FIG. 14, FIG. 15C illustrates a cross-sectional view of a portion of the semiconductor device 1500 in which the second substrate 1522 is thinned down from its back surface at one of the various stages of fabrication, in accordance with various embodiments. As shown, the second substrate 1522 is thinned down from its back surface. In some embodiments, the second substrate 1522 may be thinned down using a polishing process (e.g., a chemical-mechanical polishing (CMP) process), while having its front surface coupled to the first substrate 1502.

Corresponding to operation 1408 of FIG. 14, FIG. 15D illustrates a cross-sectional view of a portion of the semiconductor device 1500 including one or more TSVs 1534 at one of the various stages of fabrication, in accordance with various embodiments. As shown, the TSV 1534 can extend from the back surface of the thinned substrate 1522, through the thinned substrate 1522 and IMD/ILD 1530, and to the component 1508 of the first layer. Consequently, the second layer can be operatively coupled to the first layer through the TSVs 1534. The TSV 1534 can be formed through the same processes as the TSV 1504, and have the same material as the TSV 1504. Thus, the descriptions are not repeated.

Corresponding to operation 1410 of FIG. 14, FIG. 15E illustrates a cross-sectional view of a portion of the semiconductor device 1500 including a number of bonding pads 1540 coupled to the TSVs 1534, respectively, at one of the various stages of fabrication, in accordance with various embodiments. The bonding pad 1540 can allow the TSV 1534 to be electrically coupled to other components such as, for example, one or more other layers to form one of the memory systems, as discussed above. The bonding pad 1540 is formed of a conductive material. The conductive material may comprise copper, although other suitable materials such as aluminum, alloys, doped polysilicon, combinations thereof, and the like, may alternatively be utilized.

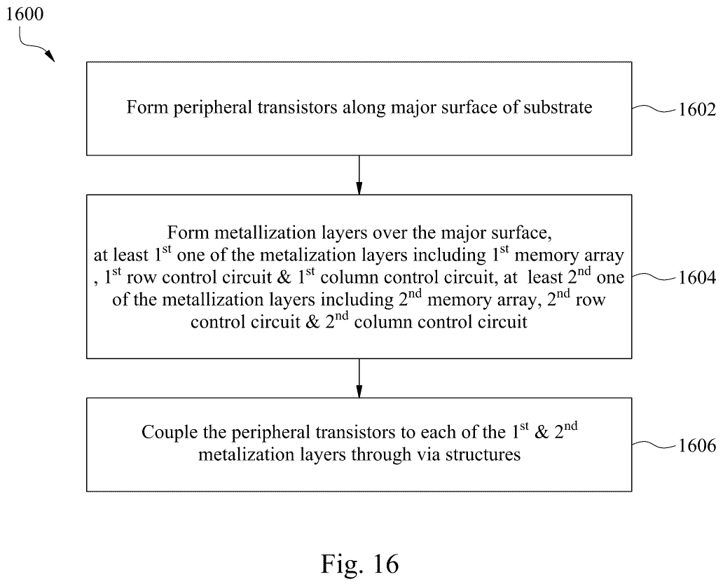

FIG. 16 illustrates a flowchart of a method 1600 to form a memory system including different layers operatively coupled to each other through via structures, according to one or more embodiments of the present disclosure. For example, at least some of the operations (or steps) of the method 1600 can be used to form a memory system discussed above. It is noted that the method 1600 is merely an example, and is not intended to limit the present disclosure. Accordingly, it should be understood that additional operations may be provided before, during, and/or after the method 1600 of FIG. 16, and that some other operations may only be briefly described herein.

The method 1600 starts with operation 1602 with forming a plurality of peripheral transistors along the major surface of a substrate. Such transistors formed along the major surface are generally referred to as a part of a front-end-of-line (FEOL) network or processing. In some embodiments, these peripheral transistors can correspond to the peripheral layer 1102 shown in FIG. 11.

The substrate may be a semiconductor substrate, such as a bulk semiconductor, a semiconductor-on-insulator (SOI) substrate, or the like, which may be doped (e.g., with a p-type or an n-type dopant) or undoped. The substrate may be a wafer, such as a silicon wafer. Generally, an SOI substrate includes a layer of a semiconductor material formed on an insulator layer. The insulator layer may be, for example, a buried oxide (BOX) layer, a silicon oxide layer, or the like. The insulator layer is provided on a substrate, typically a silicon or glass substrate. Other substrates, such as a multi-layered or gradient substrate may also be used. In some embodiments, the semiconductor material of the substrate may include silicon; germanium; a compound semiconductor including silicon carbide, gallium arsenic, gallium phosphide, indium phosphide, indium arsenide, and/or indium antimonide; an alloy semiconductor including SiGe, GaAsP, AlInAs, AlGaAs, GaInAs, GaInP, and/or GaInAsP; or combinations thereof.

The method 1600 proceeds to operation 1604 with forming a plurality of metallization layers over the major surface, at least a first one of which includes a first memory array, a first row control circuit, and a first column control circuit and at least a second one of which includes a second memory array, a second row control circuit, and a second column control circuit. Such metallization layers formed above the major surface are generally referred to as a part of a back-end-of-line (BEOL) network or processing. In some embodiments, the first metallization layer and the second metallization layer can correspond to the memory array layer 1104 and memory array layer 1106 shown in FIG. 11, respectively.

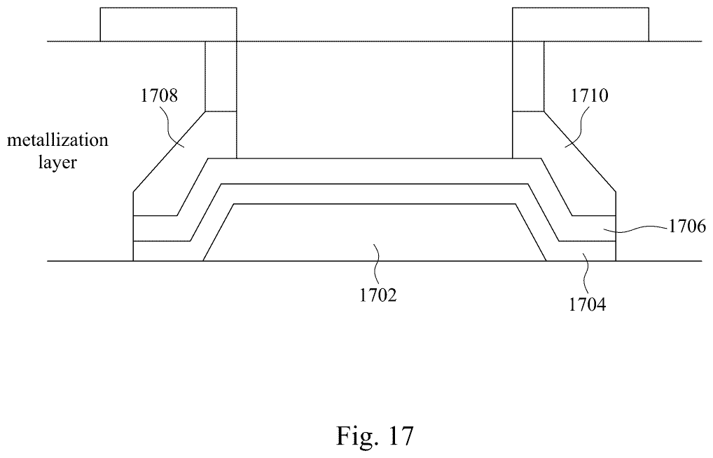

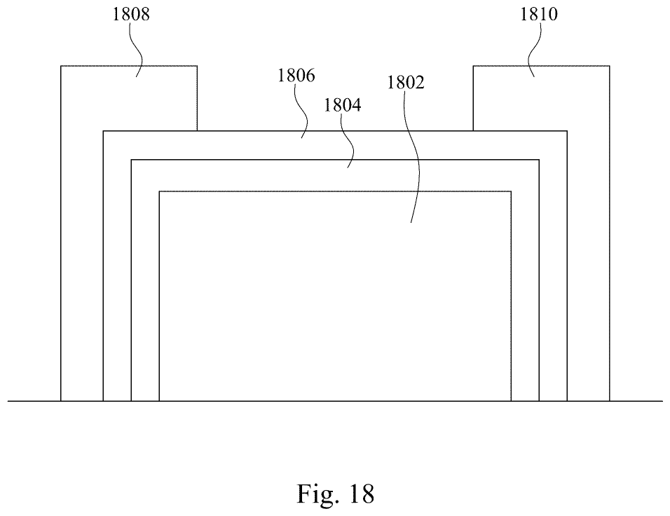

In various embodiments, the memory array and the row/column control circuit formed in the metallization layer can include a plural number of two-dimensional back-gate transistors (2D transistors) and/or a plural number of three-dimensional back-gate transistors (3D transistors), as shown in FIGS. 17 and 18, respectively. In the illustrative example of FIG. 17, the 2D transistor includes a bottom gate 1702, a gate dielectric 1704 disposed over the bottom gate 1702, a channel structure 1706 disposed over the gate dielectric 1704, and a pair of source/drain structures 1708 and 1710 disposed over the channel structure 1706. The term “two-dimensional back-gate transistor” may refer to a transistor having its gate formed as a relatively planar or thinner structure and its channel structure contacting a top surface of its gate. In some embodiments, the bottom gate 1702 includes TiN, the gate dielectric 1704 includes a high-k dielectric material (such as HfO₂), the channel structure 1706 includes InGaZnO (IGZO), and the source/drain structures 1708 and 1710 includes TiN. In the illustrative example of FIG. 18, the 3D transistor includes a bottom gate 1802, a gate dielectric 1804 disposed over the bottom gate 1802, a channel structure 1806 disposed over the gate dielectric 1804, and a pair of source/drain structures 1808 and 810 disposed over the channel structure 1806. The term “three-dimensional back-gate transistor” may refer to a transistor having its gate formed as a relatively protruding structure and its channel structure contacting multiple surfaces of its gate. In some embodiments, the bottom gate 1802 includes TiN, the gate dielectric 1804 includes a high-k dielectric material (such as HfO₂), the channel structure 1806 includes InGaZnO (IGZO), and the source/drain structures 1808 and 1810 includes TiN.

The method 1600 proceeds to operation 1606 with coupling the peripheral transistors to each of the first and second metallization layers through via structures. Such via structures can each be formed between any adjacent ones of the metallization layers. In some embodiments, the via structures can correspond to the interconnect structures 1112/1114, or at least portions of them, shown in FIG. 11, respectively.

In one aspect of the present disclosure, a memory circuit is disclosed. The memory circuit includes a first memory array comprising a plurality of first memory cells, the plurality of first memory cells configured to store a first data element; a second memory array vertically spaced from the first memory array and comprising a plurality of second memory cells, the plurality of second memory cells configured to store a second data element; and a control circuit operatively coupled to both of the first memory array and the second memory array, and configured to provide a multiply-accumulate (MAC) value at least based on simultaneously multiplying a third data element by the first data element and multiplying the third data element by the second data element.

In another aspect of the present disclosure, a memory circuit is disclosed. The memory circuit includes a first memory array formed in a first physical layer and comprising a plurality of first memory cells, the plurality of first memory cells configured to store a first data element; a second memory array formed in a second physical layer and comprising a plurality of second memory cells, the plurality of second memory cells configured to store a second data element, wherein the first physical layer and the second physical layer are vertically spaced from each other; and a control circuit operatively coupled to both of the first memory array and the second memory array. The control circuit is configured to receive a third data element; and provide a multiply-accumulate (MAC) value for the third data element multiplied by each of the first and second data elements based on simultaneously accessing the first memory array and the second memory array.

In yet another aspect of the present disclosure, a method for fabricating a memory circuit is disclosed. The method includes forming a first memory array in a first physical layer. The method includes forming a second memory array in a second physical layer. The method includes coupling the first physical layer to the second physical layer, with the first and second physical layers vertically spaced from each other. The first memory array and the second memory array are simultaneously accessed to retrieve a first data element from the first memory array and a second data element from the second memory array, and the retrieved first and second data elements are multiplied by a third data element.

As used herein, the terms “about” and “approximately” generally indicates the value of a given quantity that can vary based on a particular technology node associated with the subject semiconductor device. Based on the particular technology node, the term “about” can indicate a value of a given quantity that varies within, for example, 10-30% of the value (e.g., +10%, ±20%, or ±30% of the value).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A memory circuit, comprising:
a first memory array comprising a plurality of first memory cells, the plurality of first memory cells configured to store a first data element;
a second memory array vertically spaced from the first memory array and comprising a plurality of second memory cells, the plurality of second memory cells configured to store a second data element; and
a control circuit operatively coupled to both of the first memory array and the second memory array, and configured to provide a multiply-accumulate (MAC) value at least based on simultaneously multiplying a third data element by the first data element and multiplying the third data element by the second data element.

2. The memory circuit of claim 1, wherein the control circuit is further configured to provide the MAC value by summing a first product of the third data element and the first data element and a second product of the second data element and the third data element.

3. The memory circuit of claim 1, wherein the control circuit is further configured to simultaneously access the first memory array and the second memory array, such as to retrieve the first data element and the second data element.

4. The memory circuit of claim 1,
wherein the first memory array comprises a plurality of first local access lines and a plurality of second local access lines, each of the first memory cells operatively coupled to a corresponding one of the first local access lines and a corresponding one of the second local access lines; and
wherein the second memory array comprises a plurality of third local access lines and a plurality of fourth local access lines, each of the second memory cells operatively coupled to a corresponding one of the third local access lines and a corresponding one of the fourth local access lines.

5. The memory circuit of claim 4, wherein the plurality of first local access lines and the plurality of third local access lines are in parallel with one another, and the plurality of second local access lines and the plurality of fourth local access lines are in parallel with one another.

6. The memory circuit of claim 4, further comprising:
a first global access line connected to the plurality of first local access lines and the plurality of third local access lines; and
a second global access line connected to the plurality of second local access lines and the plurality of fourth local access lines.

7. The memory circuit of claim 6, further comprising:
a first switch connected between the first global access line and a corresponding one of the plurality of first local access lines;
a second switch connected between the first global access line and a corresponding one of the plurality of third local access lines;
a third switch connected between the second global access line and a corresponding one of the plurality of second local access lines; and
a fourth switch connected between the second global access line and a corresponding one of the plurality of fourth local access lines.

8. The memory circuit of claim 7, wherein, when providing the MAC value, the control circuit is further configured to simultaneously active the first to fourth switches.

9. The memory circuit of claim 7, wherein, when programming the first data element into the first memory array, the control circuit is further configured to:
activate the first switch and the third switch; and
deactivate the second switch and the fourth switch.

10. The memory circuit of claim 7, wherein, when programming the second data element into the second memory array, the control circuit is further configured to:
deactivate the first switch and the third switch; and
activate the second switch and the fourth switch.

11. The memory circuit of claim 1, wherein the first data element and the second data element are each a weight data element, and the third data element is an input data element.

12. The memory circuit of claim 1, wherein the first memory array is formed in a first physical layer and the second memory array is formed in a second physical layer, and wherein the first physical layer and the second physical layer are vertically spaced from each other.

13. A memory circuit, comprising:
a first memory array formed in a first physical layer and comprising a plurality of first memory cells, the plurality of first memory cells configured to store a first data element;
a second memory array formed in a second physical layer and comprising a plurality of second memory cells, the plurality of second memory cells configured to store a second data element, wherein the first physical layer and the second physical layer are vertically spaced from each other; and
a control circuit operatively coupled to both of the first memory array and the second memory array, wherein the control circuit is configured to:
receive a third data element; and
provide a multiply-accumulate (MAC) value for the third data element multiplied by each of the first and second data elements based on simultaneously accessing the first memory array and the second memory array.

14. The memory circuit of claim 13, wherein the first and second data elements are each a weight data element, and the third data element is an input data element.

15. The memory circuit of claim 13, wherein the control circuit is further configured to provide the MAC value by summing a first product of the third data element and the first data element and a second product of the third data element and the second data element.

16. The memory circuit of claim 13,
wherein the first memory array comprises a plurality of first local access lines and a plurality of second local access lines, each of the first memory cells operatively coupled to a corresponding one of the first local access lines and a corresponding one of the second local access lines;
wherein the second memory array comprises a plurality of third local access lines and a plurality of fourth local access lines, each of the second memory cells operatively coupled to a corresponding one of the third local access lines and a corresponding one of the fourth local access lines; and
wherein the memory circuit further comprises a first global access line connected to the plurality of first local access lines and the plurality of third local access lines, and a second global access line connected to the plurality of second local access lines and the plurality of fourth local access lines.

17. The memory circuit of claim 16, further comprising:
a first switch connected between the first global access line and a corresponding one of the plurality of first local access lines;
a second switch connected between the first global access line and a corresponding one of the plurality of third local access lines;
a third switch connected between the second global access line and a corresponding one of the plurality of second local access lines; and
a fourth switch connected between the second global access line and a corresponding one of the plurality of fourth local access lines.

18. The memory circuit of claim 17, wherein
when providing the MAC value, the control circuit is further configured to simultaneously active the first to fourth switches;
when programming the first data element into the first memory array, the control circuit is further configured to activate the first switch and the third switch, and deactivate the second switch and the fourth switch; and
when programming the second data element into the second memory array, the control circuit is further configured to deactivate the first switch and the third switch, and activate the second switch and the fourth switch.

19. A method, comprising:
forming a first memory array in a first physical layer;
forming a second memory array in a second physical layer; and
coupling the first physical layer to the second physical layer, with the first and second physical layers vertically spaced from each other;
wherein the first memory array and the second memory array are simultaneously accessed to retrieve a first data element from the first memory array and a second data element from the second memory array, and the retrieved first and second data elements are multiplied by a third data element.

20. The method of claim 19, further comprising:
coupling a first global access line and a second global access line to the first memory array, while decoupling the first global access line and the second global access line from the second memory array, such as to program the first data element into the first memory array;
coupling the first global access line and the second global access line to the second memory array, while decoupling the first global access line and the second global access line from the first memory array, such as to program the second data element into the second memory array; and
coupling the first global access line and the second global access line to both of the first memory array and the second memory array, such as to simultaneously access the first memory array and the second memory array.
